(19) United States
(12) Patent Application Publication
(10) Pub. No.: US 2016/0377212 A1
(43) Pub. Date: Dec. 29, 2016

(54) TELESCOPIC LOCATING STRUCTURE

(71) Applicant: JEN SIAN INDUSTRIAL CO., LTD., Taichung City (TW)

(72) Inventor: Cheng-Wei LAI, Taichung City (TW)

(21) Appl. No.: 15/186,461

(22) Filed: Jun. 18, 2016

(30) Foreign Application Priority Data
Jun. 23, 2015 (TW) 104120201

(51) Int. Cl. F16L 27/12

(52) U.S. Cl. CPC F16L 27/12

(57) ABSTRACT

A telescopic locating structure includes a linearly extending first extension member and a linearly extending second extension member. The second extension member is coaxially slidably fitted and connected with the first extension member. The second extension member s coaxially reciprocally telescopically moved relative to the first extension member. The telescopic locating structure further includes a second connection member having an engagement section slidably disposed on the second extension member. The geometrical central axis of the engagement section is eccentric to the axis of the second extension member. Accordingly, the engagement section can be engaged between the second extension member and other fixing member so as to restrict and locate the second extension member.

### BACKGROUND OF THE INVENTION

1. Field of the Invention

The present invention relates generally to a locating technique for locating elongated articles such as tubular or rod-like members after the elongated articles are telescoped, and more particularly to a telescopic locating structure.

2. Description of the Related Art

Please refer to FIGS. 1 and 2. In the conventional telescopic locating technique, an elastic press collar 3a is coaxially sandwiched between two tubular members 1a, 2a, which are coaxially fitted with each other. The inner diameter of the elastic press collar 3a is changeable. A fastening collar 4a is used to push/press the press collar 3a so as to change the inner diameter of the press collar 3a. Accordingly, the press collar 3a can tightly bind the coaxially fitted tubular member 1a so as to locate the two tubular members 1a, 2a after relatively telescoped.

Please further refer to FIGS. 3 and 4. In another telescopic locating technique, a collar 3b is coaxially fitted and connected between two tubular rods 1b, 2b, which are coaxially fitted with each other. A fastening pin 4b is disposed on one side of the collar 3b in parallel to the collar 3b. A fitting collar 5b is rotatably fitted around the fastening pin 4b. The fitting collar 5b is formed with an eccentric passage 6b. When rotating the fitting collar 5b, the wall of the eccentric passage 6b will press the fastening pin 4b so as to locate the tubular rods 1b, 2b.

In the above telescopic locating techniques, the tubular members or rod members can be steplessly located after relatively telescoped. However, the conventional telescopic locating technique includes numerous components so that the manufacturing cost is higher and it is inconvenient to process and assemble the components.

### SUMMARY OF THE INVENTION

It is therefore a primary object of the present invention to provide a telescopic locating structure. The telescopic locating structure has simplified components so that the manufacturing cost is greatly lowered and the requirement for the precision is greatly reduced. Also, it is unnecessary to over-process or over-assemble the components and the rod members or tubular members can be easily steplessly located after relatively telescoped.

To achieve the above and other objects, the telescopic locating structure of the present invention includes a linearly extending first extension member and a linearly extending second extension member. The second extension member is coaxially slidably fitted and connected with the first extension member. The second extension member is coaxially reciprocally telescopically moved relative to the first extension member. The telescopic locating structure further includes a second connection member having an engagement section slidably disposed on the second extension member. The geometrical central axis of the engagement section is eccentric to the axis of the second extension member. Accordingly, the engagement section can be engaged between the second extension member and other fixing member so as to restrict and locate the second extension member.

To speak more specifically, the telescopic locating structure of the present invention further includes a first connection member fixedly disposed at one end of the first extension member. The second connection member is connected on the first connection member and movable between an engaged position and a released position relative to the first connection member. The engagement section of the second connection member is formed with a slide hole. The slide hole is formed through a geometrical central axis of the engagement section between two ends thereof. An axis of the slide hole is eccentric to the geometrical central axis of the engagement section. The engagement section is coaxially slidably fitted on and connected with the second extension member. Accordingly, when the second connection member is positioned in the engaged position, the engagement section is forcedly deflected in a direction normal to the geometrical central axis, whereby the second extension member tightly abuts a sidewall of the slide hole to press-fit and connect the engagement section on the first connection member so as to restrict and locate the second extension member. When the second connection member is positioned in the released position, the engagement section is loosened from the first connection member to a released state, whereby the slide hole will not hinder the second extension member from axially moving and thus the second and first extension members can be axially telescopically moved relative to each other.

In the above telescopic locating structure, the engagement section is collar-shaped. One end of the engagement section has a conic configuration. The conic configuration has a curvature center as the geometrical central axis.

In the above telescopic locating structure, the first connection member has an annular socket coaxial with the first extension section. The socket has an opening directed to the conic end of the engagement section, whereby when the second connection member is positioned in the engaged position, the conic end of the engagement section is eccentrically plugged in the socket.

In the above telescopic locating structure, the first connection member has a tubular first connector fixedly disposed at one end of the first extension member. The socket is formed on an end face of one end of the first connector.

In the above telescopic locating structure, the second connection member has a tubular second connector coaxially slidably fitted on and connected with the second extension member for connecting with the first connection member. The engagement section is positioned between the first connector and the first connection member.

In the above telescopic locating structure, the first connection member has a tubular first connector coaxially disposed at one end of the first extension member for serially connecting with the second connector.

In the above telescopic locating structure, the first connection member further has a first connection section and the second connection member further has a second connection section for connecting with the first connection section. The first and second connection sections are respectively disposed between the serially connected parts of the serially connected first and second connectors.

In the above telescopic locating structure, the second connection member further has a second connection section disposed on the engagement section. The first connection member has a first connection section for connecting with the second connection section.

In the above telescopic locating structure, the first and second connection sections are complementary threads for screwing with each other.

In the above telescopic locating structure, the first and second connection sections are a socket and a boss complementary to each other.

The present invention can be best understood through the following description and accompanying drawings, wherein:

### BRIEF DESCRIPTION OF THE DRAWINGS

FIG. 1 is a perspective exploded view of a conventional technique;

FIG. 2 is a sectional view of the conventional technique;

FIG. 3 is a perspective partially sectional view of another conventional technique;

FIG. 4 is a sectional view of the other conventional technique in a not located state;

FIG. 5 is a sectional view of the other conventional technique in a located state;

FIG. 6 is a perspective exploded view of a first embodiment of the present invention;

FIG. 7 is a perspective view of the engagement section of the first embodiment of the present invention;

FIG. 8 is a perspective assembled view of the first embodiment of the present invention;

FIG. 9 is a sectional view taken along line a-a of FIG. 8, showing that the present invention is not located;

FIG. 10 is a sectional view taken along line a-a of FIG. 8, showing that the present invention is located;

FIG. 11 is a sectional view taken along line 11-11 of FIG. 10;

FIG. 12 is a sectional view of a second embodiment of the present invention;

FIG. 13 is a sectional view of a third embodiment of the present invention; and

FIG. 14 is a sectional view of a fourth embodiment of the present invention.

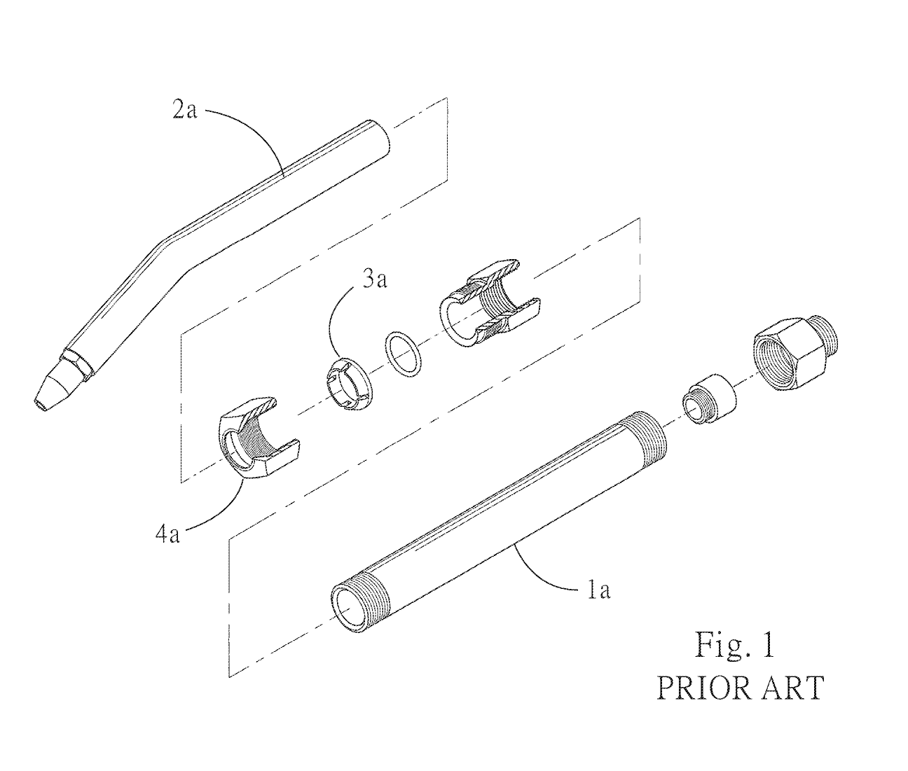

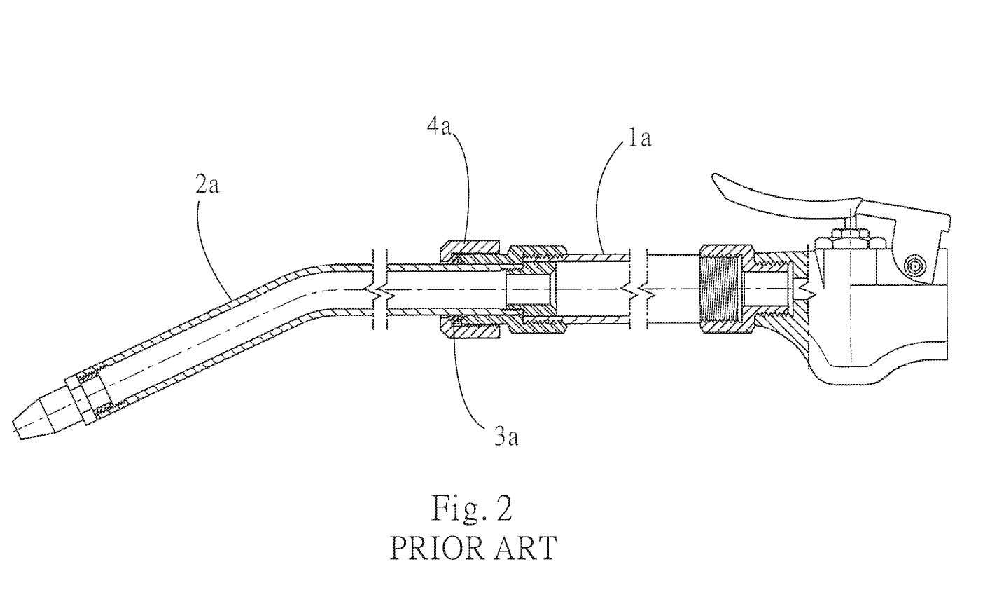

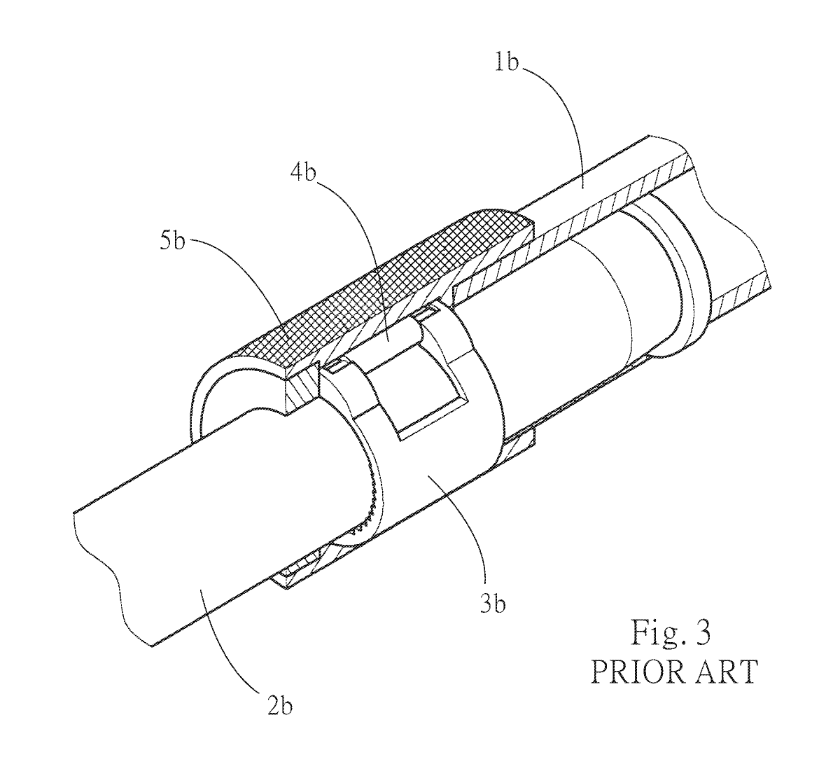

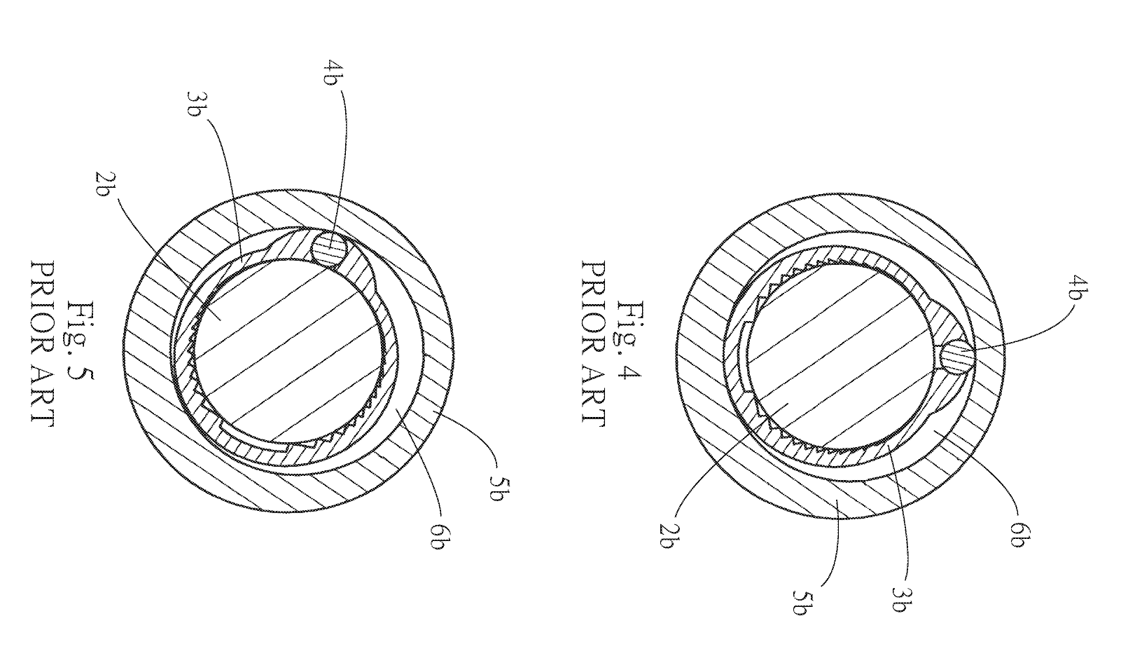

### DETAILED DESCRIPTION OF THE PREFERRED EMBODIMENTS

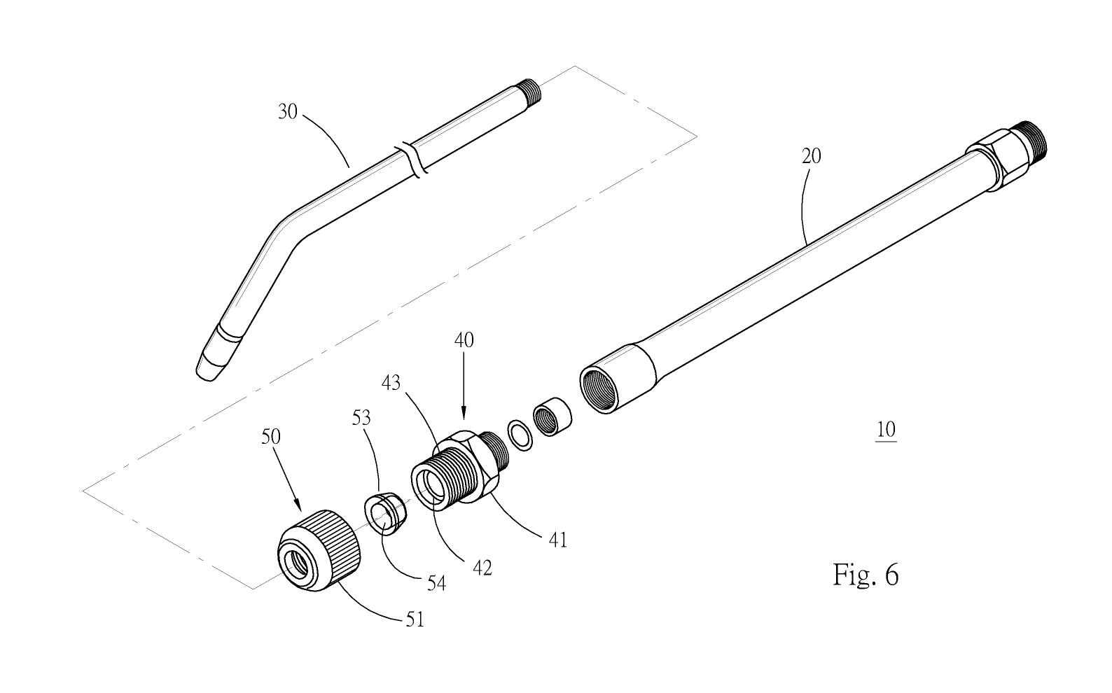

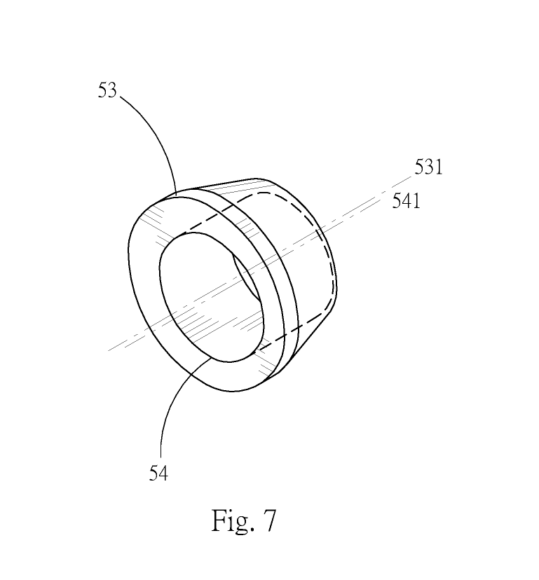

Please refer to FIGS. 6 to 11. According to a first embodiment, the telescopic locating structure 10 of the present invention mainly includes a first extension member 20, a second extension member 30, a first connection member 40 and a second connection member 50.

The first extension member 20 is a hollow circular tubular body linearly extending by a certain length.

The second extension member 30 is also a hollow circular tubular body linearly extending by a certain length. The outer diameter of the second extension member 30 is smaller than the inner diameter of the first extension member 20. Accordingly, the second extension member 30 can be coaxially slidably fitted in and connected with the first extension member 20 and axially telescopically moved relative to the first extension member 20.

The first connection member 40 has a first connector 41 in the form of a hollow circular tube. The first connector 41 has an inner diameter substantially equal to the outer diameter of the second extension member 30, whereby the first connector 41 is slidably fitted on and connected with the second extension member 30. One end of the first connector 41 is coaxially screwed in and fixedly connected with one end of the first extension member 20. An annular socket 42 is coaxially formed on the end face of the other end of the first connector 41. A threaded first connection section 43 is annularly disposed on the circumference of the other end of the first connector 41.

The second connection member 50 has a tubular second connector 51. The second connector 51 is coaxially slidably fitted on and connected with the second extension member 30. A threaded second connection section 52 is annularly disposed on the inner wall face of the second connector 51 for coaxially screwing with the first connection section 43. Accordingly, the second connector 51 can be serially connected with the first connector 41. A collar-shaped engagement section 53 is positioned between the second connector 51 and the first connector 41. One end of the engagement section 53 is outward tapered to form a conic configuration. A slide hole 54 is formed through the engagement section 53 between two ends thereof. The engagement section 53 is coaxially slidably fitted on and connected with the second extension member 30. The axis 541 of the slide hole 54 is eccentric to the geometrical central axis 531 of the conic configuration of the engagement section 53.

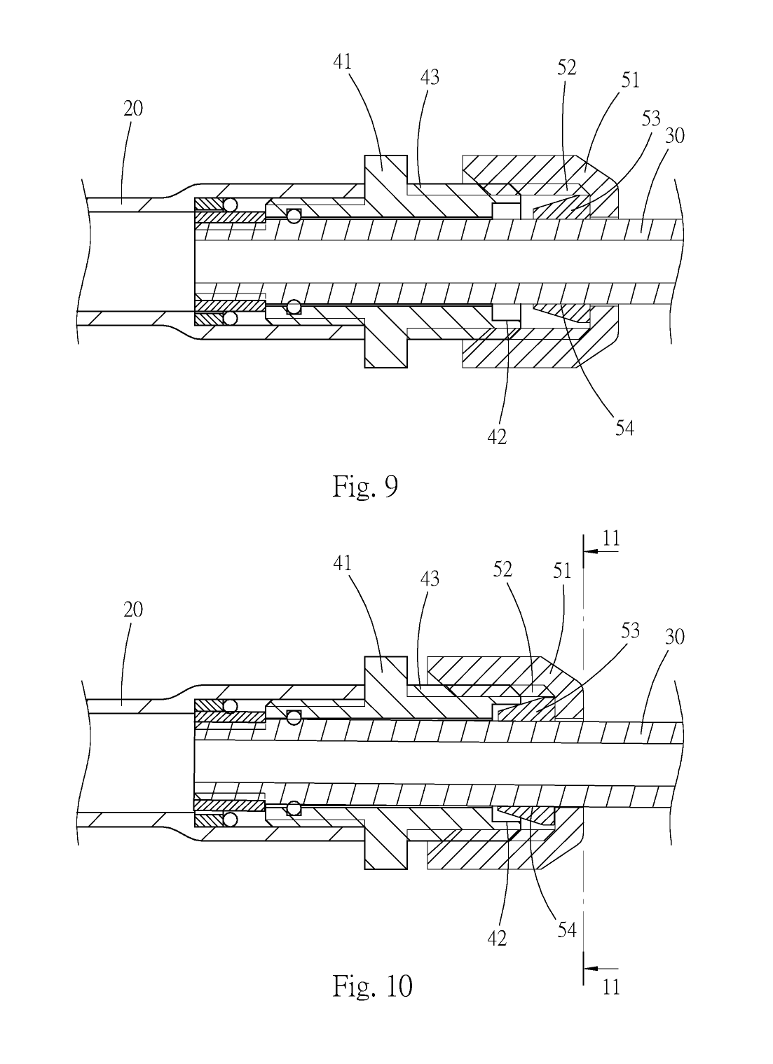

According to the above arrangement, in a normal not-located/restricted state, the second extension member 30 can be reciprocally telescopically moved relative to the first extension member 20 so as to adjust the total length of the telescopic locating structure 10 in accordance with the practical requirement. In this case, as shown in FIG. 9, the screwing depth between the first connection sections 43 of the first connector 41 and the second connection section 52 of the second connector 51 can be reduced, whereby the engagement section 53 will not interfere with the socket 42. Under such circumstance, the engagement section 53 can move within the space between the first and second connectors 41, 51 relative to the second extension section 30. Therefore, the second connection member 50 is positioned in a released position, where the second extension member 30 is allowed to axially telescopically move.

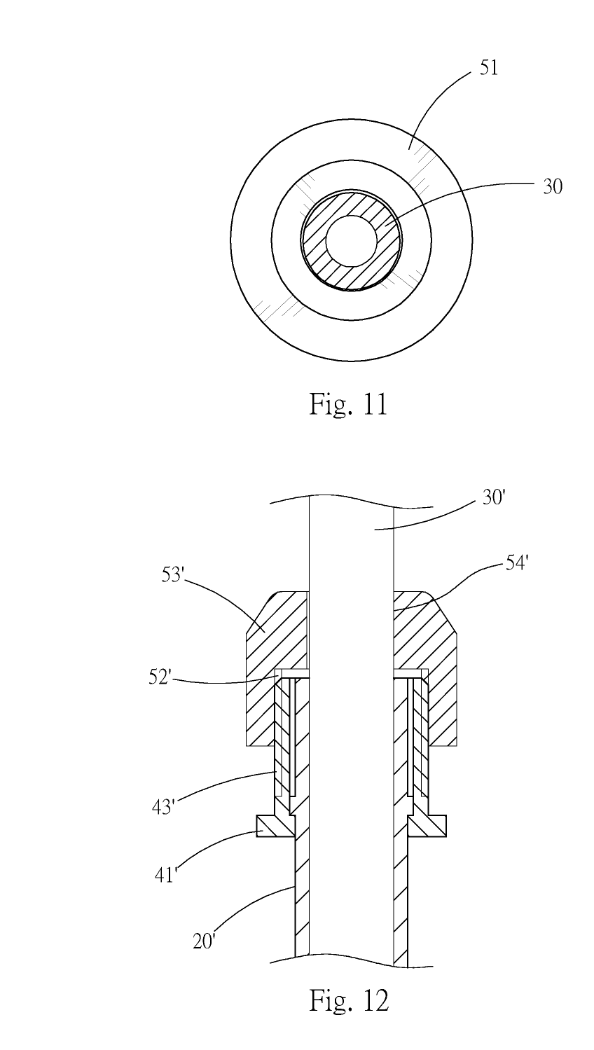

When it is desired to restrict and locate the second extension member 30, as shown in FIGS. 10 and 11, the second connection member 50 is positioned in an engaged position so as to restrict the second extension member 30 from axially telescopically moving relative to the first extension member 20. To speak more specifically, when the second connection member 50 is positioned in the engaged position, the screwing depth between the second connector 51 and the first connector 41 is increased so as to push the engagement section 53 to the position where the socket 42 is positioned. At this time, the conic end of the engagement section 53 is eccentrically plugged into the socket 42. Therefore, by means of increasing the screwing depth between the second connector 51 and the first connector 41, the plugging depth of the conic end of the engagement section 53 into the socket 42 is increased. Synchronously, the engagement section 53 is radially deflected, whereby a sidewall of the slide hole 54 distal from the geometrical central axis tightly abuts against a corresponding outer tubular wall of the second extension member 30. Under such circumstance, the second extension member 30 is eccentrically press-fitted in the slide hole 54 and the engagement section 53 is eccentrically press-fitted in the socket 42 so as to restrict the second extension section 30 and achieve a locating effect.

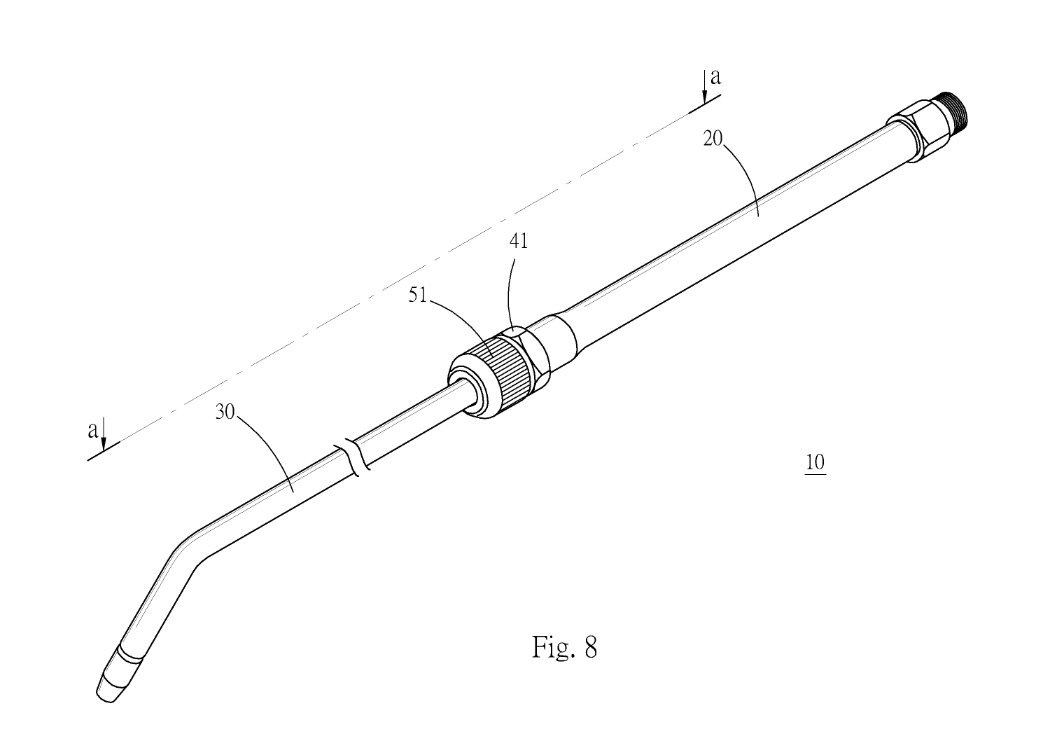

Moreover, as shown in FIGS. 6 and 8, the second extension member 30 can be such as an extending bent nozzle of a wind gun. When the second extension member 30 is restricted and located, the move of the second extension member 30 is not only restricted in the axial direction, but also restricted in the radial rotational direction. In this case, a user can readily change the direction of the extending bent nozzle according to the practical operation requirement. Also, by means of the above restricting/locating technique, the axial position or radial rotational angle of the extending bent nozzle can be steplessly located. This can achieve better effect than the conventional technique.

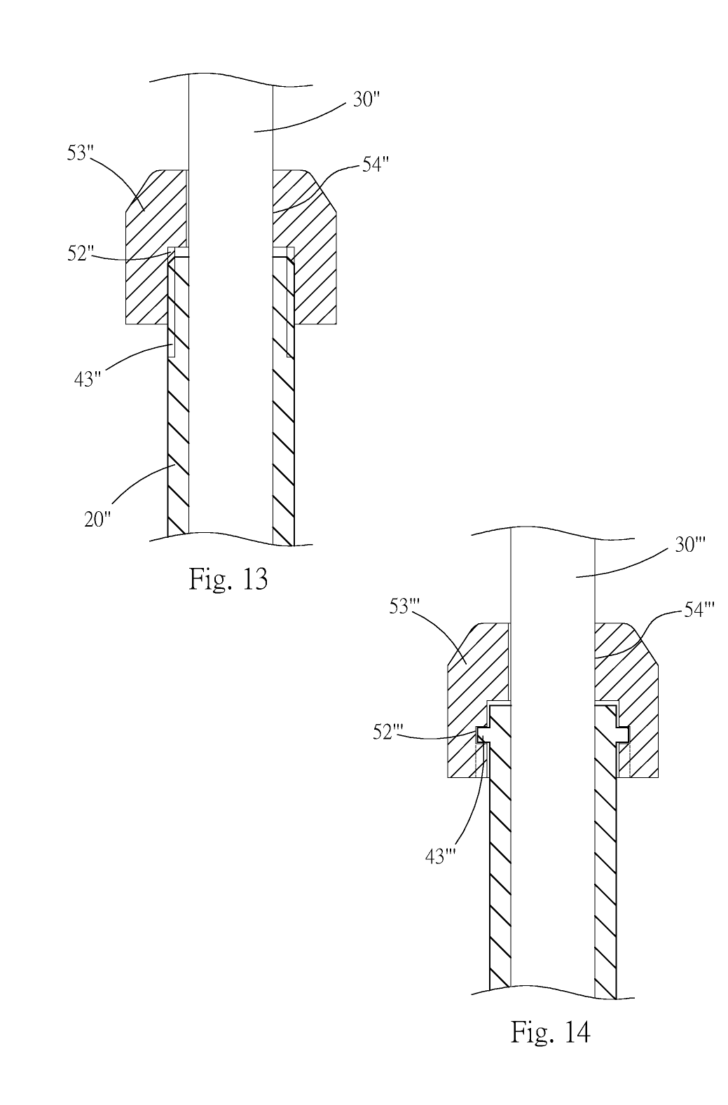

It should be noted that the present invention is characterized in that the axis 541 of the slide hole 54 is eccentric to the geometrical central axis 531 of the engagement section 53. Therefore, when the geometrical central axis 531 of the engagement section 53 is radially moved to the axis of the second extension member 30, the adjacent parts are eccentrically press-fitted and tightly engaged with each other, whereby the second extension member 30 is located. In other words, all the techniques based on the above technical characteristic are included in the protection scope of the present invention. For example, FIGS. 12 to 14 show a second embodiment, a third embodiment and a fourth embodiment.

In the second, third and fourth embodiments, the second connector and the engagement section of the first embodiment are combined into a one-piece component. As shown in FIGS. 12 to 14, the engagement sections 53′, 53″ and 53′″ all have a tubular configuration. The second connection sections 52′, 52″ and 52′″ are disposed the inner circumference of one end of the engagement sections 53′, 53″ and 53′″. Also, the axes of the slide holes 54′, 54″, 54′″ are eccentric to the geometrical central axes of the engagement sections 53′, 53″, 53′″. Accordingly, the structures of the second, third and fourth embodiments all can achieve the effect of restricting/locating the second extension members 30′, 30″, 30′″ as the first embodiment.

In addition, with respect to the connection structure between the first and second connection members, the second embodiment is different from the first embodiment in that in the second embodiment, the first connection section 43′ is annularly slidably disposed on the circumference of the first connector 41′ on the first extension member 20′. In the third embodiment, the first connection section 43″ is directly annularly disposed on the circumference of one end of the first extension member 20″. The first connection sections 43′, 43″ can be respectively screwed with the corresponding second connection sections 52′, 52″.

Moreover, the connection between the first and second connection sections not only can be achieved by screwing, but also can be achieved by other techniques. For example, as shown in FIG. 12, the first and second connection sections 43′″, 52′″ can be formed of the socket and boss of the conventional coaxial cable BNC connector. Accordingly, the first and second connection members can be coaxially connected. In other words, the connection technique between the first and second connection members is not limited to the disclosure of the present invention, but should include any coaxial connection technique that can achieve the object of coaxial connection between the first and second connection members.

The above embodiments are only used to illustrate the present invention, not intended to limit the scope thereof. Many modifications of the above embodiments can be made without departing from the spirit of the present invention.

What is claimed is:

1. A telescopic locating structure comprising:
a first extension member, which linearly extends;
a second extension member, which linearly extends, the second extension member being coaxially slidably fitted and connected with the first extension member, the second extension member being coaxially reciprocally telescopically moved relative to the first extension member;
a first connection member fixedly disposed at one end of the first extension member; and
a second connection member connected on the first connection member and movable between an engaged position and a released position relative to the first connection member, the second connection member having an engagement section, a slide hole being formed through a geometrical central axis of the engagement section between two ends thereof, an axis of the slide hole being eccentric to the geometrical central axis of the engagement section, the engagement section being coaxially slidably fitted on and connected with the second extension member, when the second connection member is positioned in the engaged position, the engagement section being forcedly deflected in a direction normal to the geometrical central axis, whereby the second extension member tightly abuts a sidewall of the slide hole to press-fit and connect the engagement section on the first connection member so as to restrict and locate the second extension member, when the second connection member is positioned in the released position, the engagement section being loosened from the first connection member to a released state, whereby the slide hole will not hinder the second extension member from axially moving and thus the second and first extension members can be axially telescopically moved relative to each other.

2. The telescopic locating structure as claimed in claim 1, wherein the second connection member has a tubular second connector coaxially slidably fitted on and connected with the second extension member for connecting with the first connection member, the engagement section being positioned between the first connector and the first connection member.

3. The telescopic locating structure as claimed in claim 1, wherein the engagement section is collar-shaped, one end of the engagement section having a conic configuration, the conic configuration having a curvature center as the geometrical central axis.

4. The telescopic locating structure as claimed in claim 3, wherein the second connection member has a tubular second connector coaxially slidably fitted on and connected with the second extension member for connecting with the first connection member, the engagement section being positioned between the first connector and the first connection member.

5. The telescopic locating structure as claimed in claim 3, wherein the first connection member has an annular socket coaxial with the first extension section, the socket having an opening directed to the conic end of the engagement section, whereby when the second connection member is positioned in the engaged position, the conic end of the engagement section is eccentrically plugged in the socket.

6. The telescopic locating structure as claimed in claim 5, wherein the first connection member has a tubular first connector fixedly disposed at one end of the first extension member, the socket being formed on an end face of one end of the first connector.

7. The telescopic locating structure as claimed in claim 5, wherein the second connection member has a tubular second connector coaxially slidably fitted on and connected with the second extension member for connecting with the first connection member, the engagement section being positioned between the first connector and the first connection member.

8. The telescopic locating structure as claimed in claim 7, wherein the first connection member has a tubular first connector coaxially disposed at one end of the first extension member for serially connecting with the second connector.

9. The telescopic locating structure as claimed in claim 8, wherein the first connection member further has a first connection section and the second connection member further has a second connection section for connecting with the first connection section, the first and second connection sections being respectively disposed between the serially connected parts of the serially connected first and second connectors.

10. The telescopic locating structure as claimed in claim 9, wherein the first and second connection sections are complementary threads for screwing with each other.

11. The telescopic locating structure as claimed in claim 9, wherein the first and second connection sections are a socket and a boss complementary to each other.

12. The telescopic locating structure as claimed in claim 1, wherein the second connection member further has a second connection section disposed on the engagement section, the first connection member having a first connection section for connecting with the second connection section.

13. The telescopic locating structure as claimed in claim 12, wherein the first and second connection sections are complementary threads for screwing with each other.

14. The telescopic locating structure as claimed in claim 12, wherein the first and second connection sections are a socket and a boss complementary to each other.
